(19) United States
(12) Patent Application Publication
(10) Pub. No.: US 2014/0207312 A1
(43) Pub. Date: Jul. 24, 2014

(54) Method And System For Customizing, On The Fly, A Vehicle Offered For Hire

(71) Applicants: Julien Rouyer, Puteaux (FR); Sandrine Ressayre, Auffargis (FR); Franck Thieulent, Saint Ouen (FR); Francis Aaron, Houilles (FR); Romain De La Ville, Port Marly (FR); Clément Lambrinos, Montreuil (FR); Yousra Chebbi, Issy Les Moulineaux (FR); Aymeric Augustin, Ville d'Avray (FR); Raphael Barrois, Paris (FR); Antoine Geron, Viroflay (FR); Sylvain Geron, Meudon (FR)

(72) Inventors: Julien Rouyer, Puteaux (FR); Sandrine Ressayre, Auffargis (FR); Franck Thieulent, Saint Ouen (FR); Francis Aaron, Houilles (FR); Romain De La Ville, Port Marly (FR); Clément Lambrinos, Montreuil (FR); Yousra Chebbi, Issy Les Moulineaux (FR); Aymeric Augustin, Ville d'Avray (FR); Raphael Barrois, Paris (FR); Antoine Geron, Viroflay (FR); Sylvain Geron, Meudon (FR)

(73) Assignee: BLUECARSHARING, Puteaux (FR)

(21) Appl. No.: 14/129,352

(22) PCT Filed: Jul. 2, 2012
(86) PCT No.: PCT/FR2012/051526

§ 371 Date: Mar. 14, 2014

(30) Foreign Application Priority Data
Jun. 30, 2011 (FR) 1155919

(51) Int. Cl. B60R 16/037

(52) U.S. Cl. CPC B60R 16/037
USPC 701/2

(57) ABSTRACT

The invention relates to a method (300) for configuring a vehicle on the fly and comprising the following steps: identifying (302, 304) a user using means of identification, loading (308), from a central site through a wireless communications network and/or from a means of identification, at least one value, known as the preferred value, of at least one parameter concerning the setup of at least one element of said vehicle, the value being associated with said identified user, and adjusting said element of the vehicle in accordance with said preferred value. The invention also relates to a system and to an installation for configuring a vehicle on the fly and to a vehicle comprising such a system.

The present invention relates to a method for on-the-fly personalization/configuration of a vehicle available for rental. It also relates to a system and an installation for on-the-fly configuration of such a vehicle.

The field of the invention is the field of collecting for rental a vehicle available for rental, and more particularly an electric vehicle. More particularly, the invention relates to the field of configuring a vehicle available for rental.

### PRIOR ART

Vehicles that operate with one or more electric batteries and sites, called rental sites, enabling the collection of a rental vehicle or the return of a rented vehicle at the end of rental, are known.

These sites generally comprise a charging terminal used to charge the batteries of the rented vehicle while the vehicle is parked.

A fleet of vehicles available for rental is generally made up of identical vehicles.

Vehicle rental agencies make available different categories of vehicles providing different levels of service.

However, for the same vehicle available for rental by different users over time, the vehicle configuration remains identical for each of these users. When the vehicle is collected for rental, the user must therefore devote a considerable amount of time to adjusting the different elements of the vehicle such as the seat position, rear view mirror orientation, etc. Such adjustments necessarily result in a considerable waste of time for short-term rentals or if the user is not familiar with the method of adjusting the different elements of the vehicle.

Some users prefer to avoid wasting this time and make these adjustments while they are driving the vehicle, which results in a high risk of accidents.

Other users prefer to avoid wasting time or reduce the time wasted and do not use some of the services available in the vehicle.

A purpose of the invention is to overcome the abovementioned drawbacks.

A further purpose of the invention is to propose a method and system for on-the-fly configuration of a vehicle.

Finally, a further purpose of the invention is to propose a method and system for on-the-fly configuration of a vehicle that prevents wasted time and the risk of accidents while enabling the user to avail himself of all of the services available on the vehicle.

### SUMMARY OF THE INVENTION

The invention proposes to achieve at least one of the aforementioned aims through a method for on-the-fly configuration of a vehicle comprising the following steps:
identifying a user,
loading, from a central site over a wireless communication network and/or from an identification means, at least one value, called the preferred value, of at least one adjustment parameter of at least one element of the vehicle, the value being associated with said identified user, and
adjusting said element of the vehicle as a function of said preferred value.

The method according to the invention therefore makes it possible, as a function of an identifier of a user, to load, particularly from a remote site, a preferred value for an adjustment parameter of an element of a vehicle and adjust this vehicle element without potentially time-consuming and troublesome intervention on the part of the user being necessary. Thus, the method according to the invention makes it possible to personalize a vehicle on the fly.

As a result of the method according to the invention, the configuration/personalization of a vehicle takes place automatically as soon as the user identifies himself. Thus, the method according to the invention makes it possible to prevent the user from wasting time or risking an accident on collection of a vehicle available for rental.

The invention also makes it possible to prevent the user from giving up the use of a service available in the vehicle. The user does not have to find out how to adjust such and such an element of the vehicle as these adjustments are made directly by the method according to the invention.

The method according to the invention can be implemented when the user arrives at the vehicle collection site from the time when he identifies himself, for example on a rental terminal or a charging terminal, or directly on the vehicle.

Identification can be by reading an RFID chip or biometric identification. However, identification can take place by other means, such as a key or a keypad used to enter an identifier.

The method according to the invention can also comprise at least one step of saving a preferred value of at least one parameter in at least one storage means located on the central site and/or the identification means.

In a first embodiment, at least one saving step can be carried out during prior use of the vehicle or of another vehicle, said saving step comprising the transmission of data relating to the preferred value to the central site over the communication network and/or to the identification means. In this case, the user using the vehicle or another vehicle makes an adjustment to the element in question, for example his preferred radio stations, the angle of the seats or the orientation of the rear view mirrors. Sensors measure the adjustment values and send them to the central site, for example by means of a communication module. The central site then saves these values as preferred values in a database in association with the user's identifier and optionally with the identifier of the vehicle or of a type of vehicle.

In a second embodiment, at least one saving step can be carried out by a remote connection to said central site from a communication device independently of the use of a vehicle. In this case, the remote site can be accessed through a user or subscriber interface, making it possible for the user to enter one or more preferred values for one or more parameters. Such a saving step can be carried out at any time and more particularly at the time when the user subscribes to a rental service.

Advantageously, at least one preferred item of data can relate to at least one parameter selected from the following list:
orientation of a rear view mirror of said vehicle,
position of a seat of the vehicle,
display of data on a display screen,
preferred data source, such as a radio station frequency,
navigation addresses,
steering wheel orientation,
welcome message,
audio and/or video content, and
telephone number/data.

The step of adjusting at least one element can comprise a step of modifying the position of the element. It can also comprise a step of storing the preferred value in the element's memory, particularly in a predetermined location in the element's memory.

In this latter case, the method can comprise a step of deleting the stored preferred values. This step is in particular triggered when the vehicle is notified of the end of rental by the central site. This makes it possible to ensure that the user's personal data remain confidential.

According to another aspect of the invention, a system for on-the-fly configuration of a vehicle is proposed, comprising:
at least one means of identifying a user,
at least one means, called communication means, loading, from a central site over a wireless communication network and/or from an identification means, at least one value, called the preferred value, of an adjustment parameter of at least one element of said vehicle, the value being associated with said identified user, and
at least one means of adjusting said element of the vehicle as a function of said preferred value.

Advantageously, the communication means can also be arranged to save a preferred value of at least one parameter in at least one storage means located on the central site, during prior use of the vehicle or of another vehicle.

The system according to the invention can also comprise, for at least one element to be configured, at least one sensor for measuring a preferred value.

According to another aspect of the invention, a vehicle comprising a system for on-the-fly configuration according to the invention is proposed.

According to yet another aspect of the invention, an installation for on-the-fly configuration of a vehicle is proposed, comprising:
at least one configuration system according to the invention; and
at least one remote site comprising:
   at least one database arranged to store at least one item of data, called preferred data, relating to an adjustment parameter of at least one vehicle, in association with at least one user identifier, and
   a module for communicating with at least one configuration system according to the invention over a wireless communication network.

The invention applies particularly to the management of a fleet of interchangeable electric vehicles intended for rental and for which a plurality of rental stations is provided.

Other advantages and characteristics of the invention will become apparent on examination of the detailed description of an embodiment which is in no way limitative, and the attached diagrams, in which:

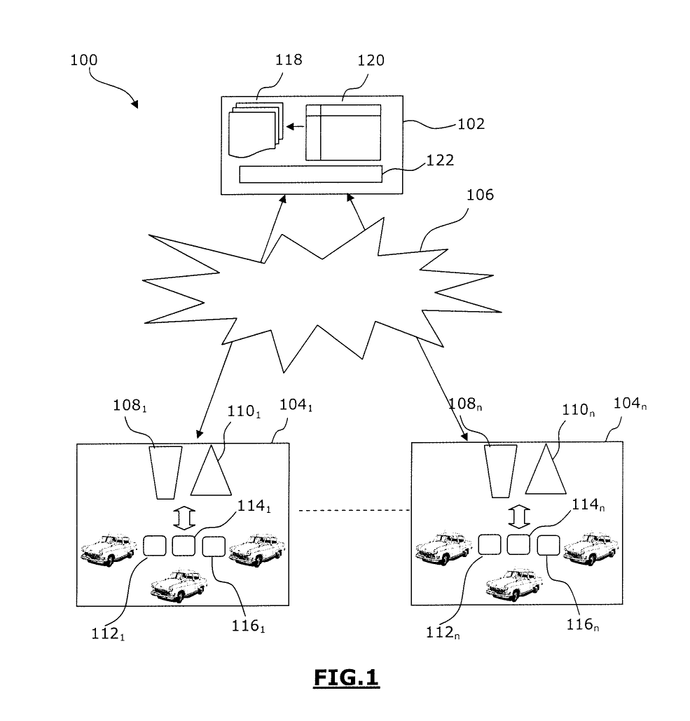

FIG. 1 is a diagrammatic representation of a management system for a fleet of vehicles available for rental;

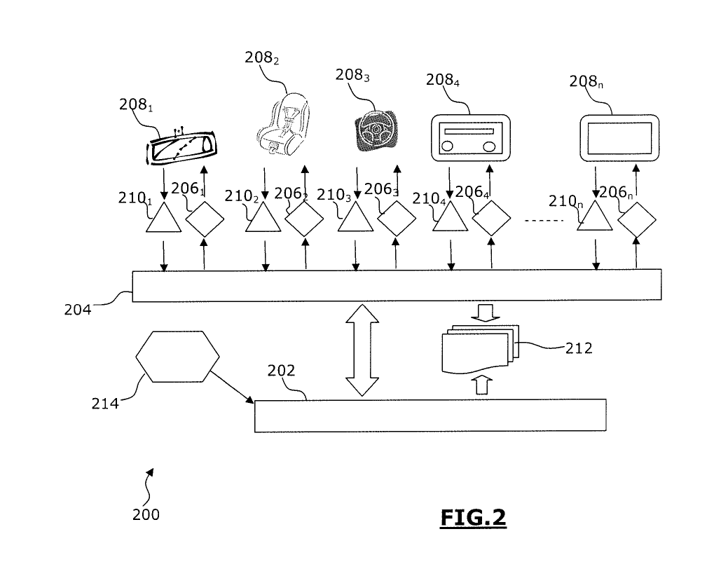

FIG. 2 is a diagrammatic representation of a system according to the invention;

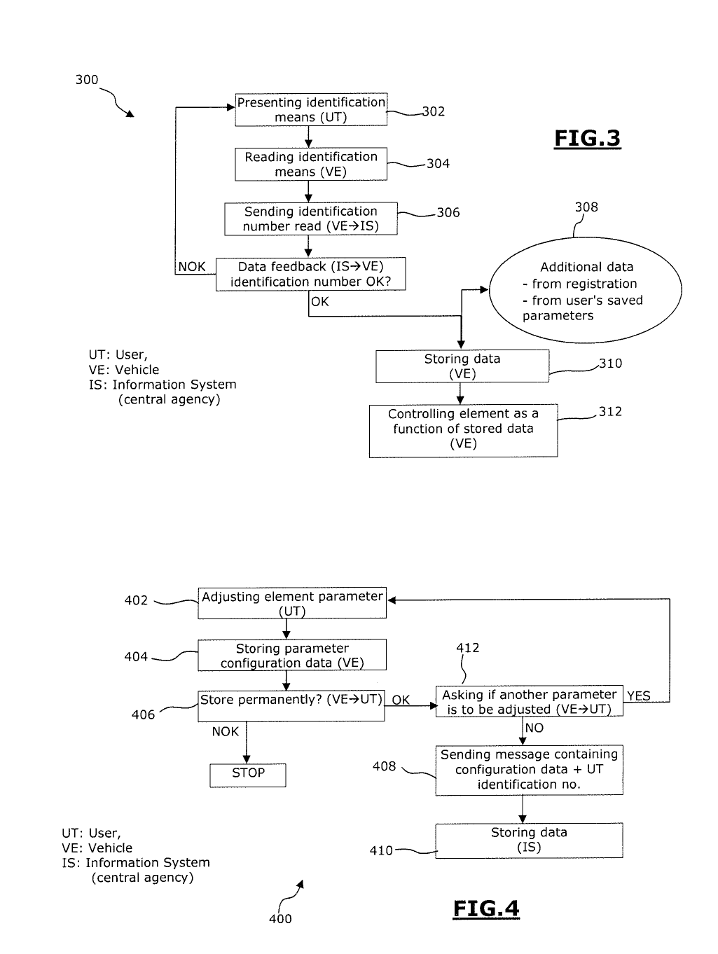

FIG. 3 is a diagrammatic representation of a phase of configuring/personalizing a vehicle according to the invention; and

FIG. 4 is a diagrammatic representation of a phase of saving a configuration of a vehicle according to the invention.

It is understood that the embodiments which will be described below are in no way limitative. In particular, variants of the invention can be envisaged that comprise only a selection of the features described below in isolation from the other features described, if this selection of features is sufficient to provide a technical advantage or to distinguish the invention from the prior art. This selection comprises at least one preferably functional feature without structural details, or with only some of the structural details if this part alone is sufficient to provide a technical advantage or to distinguish the invention from the prior art.

In particular all the variants and embodiments described can be combined if there is no technical objection to this combination.

FIG. 1 is a diagrammatic representation o f an overall management system for a fleet of electric vehicles available for rental.

The system 100 shown in FIG. 1 comprises a central site 102 (also called central agency in the remainder of the description) connected to several sites, or stations, 104₁-104ₙ, called rental sites by means of a wireless communication network 106, for example GPRS, or a wired network, for example of DSL type. Preferably, each station is connected to the central site via two separate networks, which enables continuous connection even if one of the networks fails.

Each rental station comprises a subscription terminal 108 for registering a new subscriber, a rental terminal 110 for the rental of a vehicle and several charging terminals 112-116, each charging terminal being provided for charging a vehicle equipped with an electric battery at a parking space.

The central site 102 can be connected directly to each of the terminals of a rental station 104 by means of the network 106 or solely at the subscription terminal and/or the rental terminal and/or the charging terminals 112-116.

At least two terminals of a rental station are connected to each other over a wired connection (not shown).

The central site 102 is also arranged in order to be connected to an electric vehicle comprising a data connector to one or more elements of the vehicle and/or user communication interface, by means of a GPRS network. Each vehicle is for that reason equipped with a GSM chip.

The central site 102 is also arranged to exchange information with a portable communication device such as a PDA, a mobile phone, etc., carried by an operator of the rental service and also connected to the central site by means of a GPRS network.

The system makes it possible to manage a plurality of vehicles each comprising a control unit capable of communicating with the central agency and with different elements of the vehicle, and a user interface.

Users are capable of interacting with the different terminals and with the different elements of the vehicles. Moreover, the vehicle rental service with the system according to the invention can also be carried out with the help of the operators and their mobile terminal such as a PDA, who can intervene in the service.

The central site 102 also comprises a database 118 in which preferred values of one or more adjustment parameters of one or more elements of a vehicle are saved in association with a user identifier and optionally an identifier of a vehicle or of a type of vehicle.

The database 118 is updated whenever a new preferred value is added, deleted or modified as communicated either from a vehicle or over a connection by means of a user interface 120 accessible to the user over a communication network, such as the Internet.

The central site 102 also comprises a module 122 for communicating with one or more vehicles over the network 106 directly or indirectly via a terminal.

The elements of a system for on-the-fly configuration of a vehicle according to the invention will now be described with reference to FIG. 2.

The system 200 shown in FIG. 2 comprises a communication module 202 enabling the configuration system 200 to communicate directly with the central site particularly using a GPRS network, or via a charging, rental or subscription terminal.

The system 200 also comprises a control module 204 used to control at least one adjustment means 206₁-206ₙ, associated with an element/member 208₁-208ₙ of a vehicle (not shown), and used to adjust or configure this element as a function of instructions received from the control module 204. Each adjustment means can be an automated mechanical means such as a motor used to adjust the position of a rear view mirror 208₁, a seat 208₂ or a steering wheel 208₃, or an electrical/electronic means used to adjust an analogue/digital audio and/or video content reader such as a radio 208₄ or a navigation system (GPS) 208ₙ.

The system 200 also comprises at least one sensor means 210₁-210ₙ for each of the members/elements 208, used to measure at least one value of an adjustment parameter of an element/member 208 of the vehicle and send this value to the control module as a preferred value.

The system 200 also comprises means 212 of storing data on the vehicle and RFID or biometric means 214 of identifying a user by reading an identifier. When the identification module 214 is arranged on the vehicle, it communicates with the communication module 202.

An example of configuration/personalization of a vehicle will now be described with reference to FIG. 3.

When the user takes possession of a vehicle, for example at the start of rental, he identifies himself. To this end, he presents an RFID identification badge to the identification means 214 during a step 302. An identifier is read during a step 304. The identifier read is sent to the communication module 202, which sends it to the central site during a step 306. If the central site does not recognize the identifier read, steps 302 to 306 are repeated.

If the central site recognizes the identifier read and preferred values exist for this identifier, the central site sends to the communication module 202 the preferred values for this user during a step 308.

The preferred values received by the communication module 202 are stored on the vehicle in a predetermined location in the vehicle's memory during a step 310, which can be optional, particularly for the elements the position of which is to be adjusted.

The control module then controls each of the adjustment means in question, if necessary, to adjust the element/member in question during a step 312 as a function of the preferred value received. The step 312 is in particular necessary for elements the position of which is to be changed. The vehicle is thus configured and personalized.

An example of saving a preferred value for an adjustment parameter of an element/member of the vehicle, from the vehicle, will now be described with reference to FIG. 4.

When the user wishes to modify or add a new preferred value, he adjusts the element/member 208 of the vehicle during a step 402.

The adjustment value is then measured by sensor means and stored on the vehicle during a step 404.

The user is then questioned to confirm that he wishes to store this value permanently as a preferred value during a step 406.

If he does not, the process is stopped.

If he does, the preferred value and the user's identifier are sent to the central site during a step 408 and the value is stored in a step 410, in a user profile associated with the identifier, and in a field associated with the parameter that it is used to adjust.

During an intermediate step 412, carried out before the sending step 408, the user can be questioned to determine if he wants to save a new preferred value permanently for the same element/member or for a different element/member.

If he does, steps 402 to 406 are repeated for each new preferred value or each element/member of the vehicle that the user wishes to personalize/configure.

If he does not, the method goes to step 408.

The overall method according to the invention comprises firstly a first initialization sequence in which the user who has rented a first vehicle:
selects at least one favourite configuration of a parameter for a member of the vehicle on an interface element of the vehicle and requests that this configuration be saved,
the first vehicle sends an item of data relating to this configuration of the parameter to an external element (central agency or RFID card), and
the external element stores the item of data relating to the favourite configuration of the parameter so that it is associated with the user.

The overall method then comprises a personalization sequence of a second vehicle, different from the first vehicle or not, in which, once a second vehicle is allocated to a user:
the external element, i.e. the central site or RFID card, sends to the second vehicle, optionally following a request, at least one item of data relating to a configuration relating to a user regarding a parameter of a member of the vehicle, and
if applicable, the second vehicle modifies the configuration of the parameter of the member of the vehicle so that it matches the user's favourite configuration.

The vehicle members that can be acted upon are, for example:
an on-board computer for a type of presentation, a welcome message, for example, use of the user's first name or display of data preferred when driving, saving of personal data,
an FM tuner, for example, favourite radio stations,
a GPS, for example favourite navigation options, frequently used addresses,
a rear view mirror,
a seat,
etc.

It will be noted that for some parameters, it is not necessary to use the initialization process, as some information is stored intrinsically by the central agency and/or an RFID identification card allocated to the user when the user registers with the vehicle rental or use service, such as his first name or the type of user he is (monthly or annual subscriber, one-off user or service employees).

For some members, such as the on-board computer, the GPS or the FM tuner, the step of modifying the configuration consists of saving data in the memory of these members.

In this type of configuration, it can even be envisaged to allocate to the user a memory space on the central agency's servers, enabling the user to store several pieces of music that will be uploaded to the vehicles that he will subsequently use. The user can in fact connect a USB device to the on-board computer, which could enable him to upload music that he owns elsewhere.

It will be noted that in a particular embodiment of the invention, the on-board computer also carries out the GPS and FM tuner functions.

For certain parameters relating to certain members, the vehicle comprises a position sensor for the member and a motorized mobile element driving the movement of the member. In this case, during the initialization sequence, the position of the vehicle member can be measured and, during the personalization sequence, the movement of the mobile element is controlled.

It can also be envisaged that, when the system detects that the user's rental of the vehicle has ended, certain favourite configurations are modified, and in particular the data stored in certain members of the vehicle are deleted.

Certain components of the system described with reference to FIG. 2 can be components already present elsewhere on the vehicle.

Generally, the vehicle in question can comprise a communication unit, connected to a GPRS network and used to communicate with the central agency.

The vehicle can also comprise one or more identification means, namely RFID readers used to identify the user by means of a personalized card. Each reader can have a particular function, for example opening the charging lid, opening the doors, starting, or a single reader can carry out several or all of the aforementioned functions. The identification means could also be different from those described (barcode, keypad, etc.).

The vehicle also comprises a control unit (or module) connected to the CAN bus of the vehicle in order to obtain information regarding different members thereof, and to different members of the vehicle that it can control. The module can also be connected to the identifier reader and to a communication unit comprising at least one GPRS antenna to act as an interface between these members and the remote central agency. The preferred values regarding the elements the position of which is to be modified are generally sent to this module, which is capable of controlling at least certain mechanical and/or electrical devices in the vehicle.

The vehicle can also comprise an on-board computer, also connected to the communication unit and capable of communicating with the central agency by this means. This computer forms a user interface, unlike the module, the action of which is transparent to him. The on-board computer is only connected to the vehicle unit via the GPRS network and the central agency. It carries out the GPS and FM tuner functions. To this end, it comprises a USB port to enable a user to connect a USB key. It can also be used to call a call centre in the event of a problem. The preferred values regarding the elements relating to the user interface are generally sent to this on-board computer, which stores these values in predetermined locations in its memory.

It will be noted that the control unit and the on-board computer could also be combined or communicate by other means than those described, for example internally within the vehicle. Similarly, the GPS and the FM tuner could not be incorporated into the on-board computer. They could also not be incorporated into the vehicle.

Of course, the invention is not limited to the examples that have just been described.

1-10. (canceled)

14. A method for on-the-fly configuration of a vehicle, comprising the following steps:
identifying a user by identification means,
loading, from a central site over a wireless communication network, at least one value, called the preferred value, of at least one adjustment parameter of at least one element of said vehicle, the value being associated with said identified user, and
adjusting said element of the vehicle as a function of said preferred value.

15. The method according to claim 14, wherein saving the at least one preferred value of at least one parameter in at least one storage means located on the central site.

16. The method according to claim 15, wherein saving the at least one preferred value is carried out during prior use of the vehicle or of another vehicle, said saving step comprising the transmission of data relating to the preferred value to the central site over the communication network.

17. The method according to claim 15, wherein saving the at least one preferred value is carried out by a remote connection to said central site from a telecommunication device independently of the use of a vehicle.

18. The method according to claim 14, wherein the at least one preferred value relates to at least one parameter selected from the following list:
orientation of a rear view mirror of said vehicle,
position of a seat of the vehicle,
display of data on a display screen,
preferred data source, such as a radio station,
navigation addresses,
steering wheel orientation,
welcome message,
audio and/or video content, or
telephone number/data.

19. The method according claim 14, wherein adjusting said element comprises modifying the position of at least one element of the vehicle.

20. The method according to claim 14, wherein adjusting said element comprises storing preferred values in the memory of at least one element.

21. The method according to claim 20, further comprising deleting preferred values from the element's memory.

22. The method according to claim 21, wherein deleting preferred values is triggered by an end of rental notification sent to the vehicle by the central site.

23. A system for on-the-fly configuration of a vehicle, comprising:
at least one means of identifying a user,
at least one means, called communication means, loading at least one value, called the preferred value, of an adjustment parameter of at least one element of said vehicle, associated with said identified user, from a central site over a wireless communication network, and
at least one means of adjusting said element of said vehicle as a function of said preferred value.

24. The system according to claim 23, wherein the communication means is also arranged to save a preferred value of at least one parameter in at least one storage means located on the central site, during prior use of the vehicle.

25. The system according to claim 23, further comprising, for at least one configurable element, at least one sensor for measuring a preferred value.

26. A vehicle comprising an on-the-fly configuration system according to claim 23.

27. An installation for on-the-fly configuration of a vehicle, comprising:
at least one configuration system according to claim 23; and
at least one remote site, called the central site, comprising:
at least one database arranged to store at least one item of data, called preferred data, relating to an adjustment parameter of at least one vehicle, in association with at least one user identifier, and
a module for communicating with the at least one configuration system over a wireless communication network.
